(19) United States
(12) Patent Application Publication
(10) Pub. No.: US 2008/0164679 A1
(43) Pub. Date: Jul. 10, 2008

(54) Hitch Pin

(76) Inventor: Kenneth L. MacDougall, Waverley (CA)

Correspondence Address: BROOKS KUSHMAN P.C., 1000 TOWN CENTER, TWENTY-SECOND FLOOR, SOUTHFIELD, MI, 48075, US

(21) Appl. No.: 11/720,484

(22) PCT Filed: Oct. 7, 2005
(86) PCT No.: PCT/CA05/01539

§ 371 Date: May 30, 2007

(30) Foreign Application Priority Data
Dec. 3, 2004 (CA) 2,489,068

(51) Int. Cl. B60D 1/02; B60D 1/36

(52) U.S. Cl. 280/515; 280/507

(57) ABSTRACT

The present invention relates to a quick and easily released hitch pin (1) used for securing the coupling of a trailer or similar implement onto a trailer hitch. The hitch pin (1) comprises a guide member (4), pin member (2) and handle. Linkage means (5) provided in the pin member (2) connecting the guide member (4) and the handle (3), allows for the handle (3) to coordinately move the guide member (4) between a first position, where the handle (3) and guide member (4) are substantially aligned with the pin member (2), and a second position where the handle (3) and guide member (4) form an angle to the pin member (2). When the handle (3) and guide member (4) are in the first position, the hitch pin (1) can be easily inserted through a hitch orifice. Once positioned in the hitch orifice, the handle (3) can be physically, or by the force of gravity, moved to the second position to limit lateral movement of the hitch pin (1) through the hitch orifice.

### FIELD OF THE INVENTION

The present invention relates to a hitch pin used for securing the coupling of two objects together, and more specifically, to a quick release trailer hitch pin for rapidly securing the coupling of a trailer or similar implement onto a trailer hitch.

### BACKGROUND OF THE INVENTION

Hitch pins conventionally used to secure the coupling of a trailer or similar implement onto a trailer hitch comprise a pin with one end dimensioned or angled to prevent movement through a hitch orifice and the opposite end dimensioned to be substantially smaller than the hitch orifice. The narrow end of the hitch pin is then inserted through the hitch orifice and secured into place by a hitch pin clip, cotter pin, or presto pin, which is inserted through a small hole in the vicinity of the narrow end of the hitch pin. A major disadvantage of this hitch pin is that the hitch pin clip is easily misplaced, lost or dropped in the snow, sand or grass. Moreover, at night illumination is required to insert the hitch pin clip through the small hole. A further disadvantage of the conventional hitch pin is that the hitch pin clip can be easily displaced during movement of the trailer, which can lead to the hitch pin becoming dislodged and the trailer potentially becoming detached. To address some of these limitations hitch pins that do not rely on hitch pin clips for securing the hitch pin in place have been disclosed.

Hahka (U.S. Pat. No. 6,193,261 issued Feb. 21, 2001) describes a quick release hitch pin including an elongated member, a handle and a spring having on its inner end a plunger which is located between two balls. When the plunger is pressed, the balls are forced outwardly, thereby forming a locking member to prevent removal of the pin.

Delorme (U.S. Pat. No. 5,199,733) describes a hitch pin having a cylindrical body, a shaft cavity formed within the cylindrical shaft, a top plate member, a lock rod, a lock means contained within the cylindrical shaft and actuator means mounted on the lock rod to move the lock means outwardly effecting locking of the pin.

Hardin (U.S. Pat. No. 4,125,048) describes a hitch pin having a locking member, a loop handle, a bore in the main body and a rod along the bore attaching the handle and the locking member. The loop handle functions to move the rod to a position perpendicular to the main tubular body, thereby locking the pin.

Goodlove (U.S. Pat. No. 4,555,125) and Mayer (U.S. Pat. No. 4,526,396) both disclose hitch pins with a “C” shaped handle attached to one end of the pin and a spring that attaches the two elements, which also automatically locks the handle preventing removal of the pin.

### SUMMARY OF THE INVENTION

Although the prior art teaches of hitch pins that do not rely on hitch pin clips to secure them in place, none of the prior art discloses a hitch pin similar to present invention. Therefore, it is an object of the present invention to provide a hitch pin which can easily be inserted into a hitch orifice and locked into place by simply moving the handle downwards.

According to an aspect of the present invention, there is provided a hitch pin comprising a pin member having a first end and a second end and dimensioned to fit into a hitch orifice, the pin member defining a longitudinal axis; a handle connected pivotally to the first end of the pin member for movement between a first position in which the handle is substantially aligned with the pin member and a second position in which the handle is disposed at an angle to the pin member; a guide member dimensioned to fit into the hitch orifice, the guide member connected pivotally to the second end of the pin member for movement between a first position in which the guide member is substantially aligned with the pin member and a second position in which the guide member is disposed at an angle to the pin member; and linkage means connected at one end to the handle and at the other end to the guide member for transmitting a pivotal movement of the handle to a corresponding pivotal movement of the guide member.

Typically, the linkage means is provided as a flexible cable. To accommodate the flexible cable the pin member has a channel extending between the first end and the second end thereof. The channel is dimensioned to receive the cable and allows for the sliding movement of the cable along the channel. The cable is connected to the handle and to the guide member at a point each offset from the longitudinal axis of the pin member. Alternatively, the linkage means can be provided as a rigid linkage connected at one end to the handle at a point offset from the longitudinal axis and connected at the other end to the guide member at a point offset from the longitudinal axis, so that pivotal movement of the handle causes corresponding pivotal movement of the guide member.

According to a further aspect of the present invention, a locking mechanism can be provided in the handle of the hitch pin. The locking mechanism prevents movement of the handle from the second position to the first position when in a locked position. The locking mechanism is provided to prevent unauthorized removal of the hitch pin when being used to couple two articles together.

### BRIEF DESCRIPTION OF THE DRAWINGS

FIG. 1 is a top cutaway view of an embodiment of a hitch pin of the present invention;

FIG. 2 is an end view of the handle in the vicinity of the pin member;

FIG. 3 is an end view of the guide end in the vicinity of the pin member;

FIG. 4 is a side view of an embodiment of a hitch pin of the present invention;

FIG. 5 is a side cutaway view of an embodiment of a hitch pin of the present invention;

FIG. 6 is a side view of an embodiment of a hitch pin of the present invention;

FIG. 7 is a side cutaway view of an embodiment of a hitch pin of the present invention; and

FIG. 8 is a side cutaway view of an embodiment of a hitch pin of the present invention.

### DETAILED DESCRIPTION OF THE INVENTION

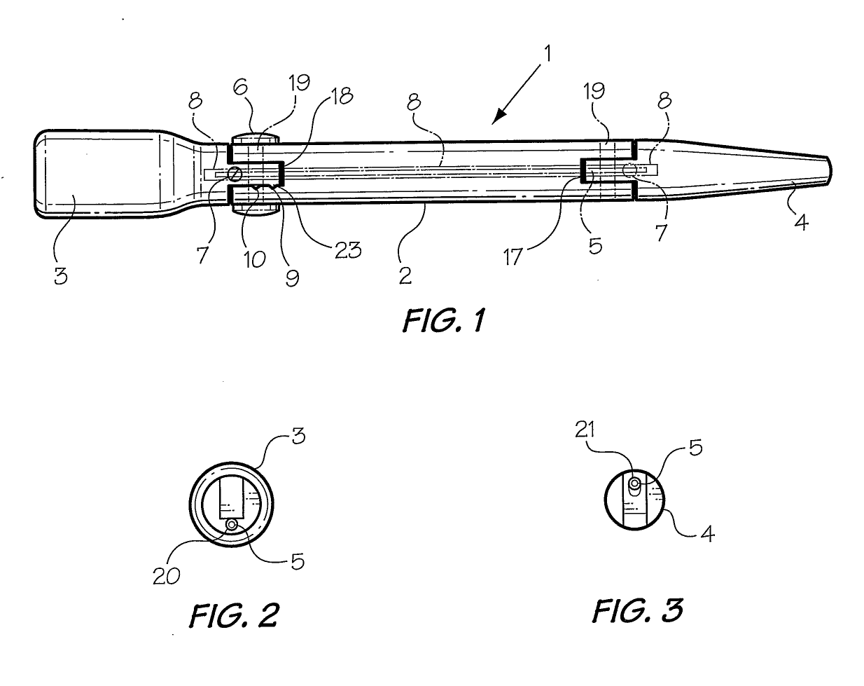

Although other applications may be envisioned for the hitch pin of the present invention, such as reversibly coupling two articles together through an orifice, the use of the hitch pin of the present invention is particularly advantageous in securing the coupling of trailers or other implements onto trailer hitches. Accordingly, without intending to limit the present invention to the embodiments described herein, the invention will be described below in further detail having regard to the hitch pin shown in FIGS. 1 to 8.

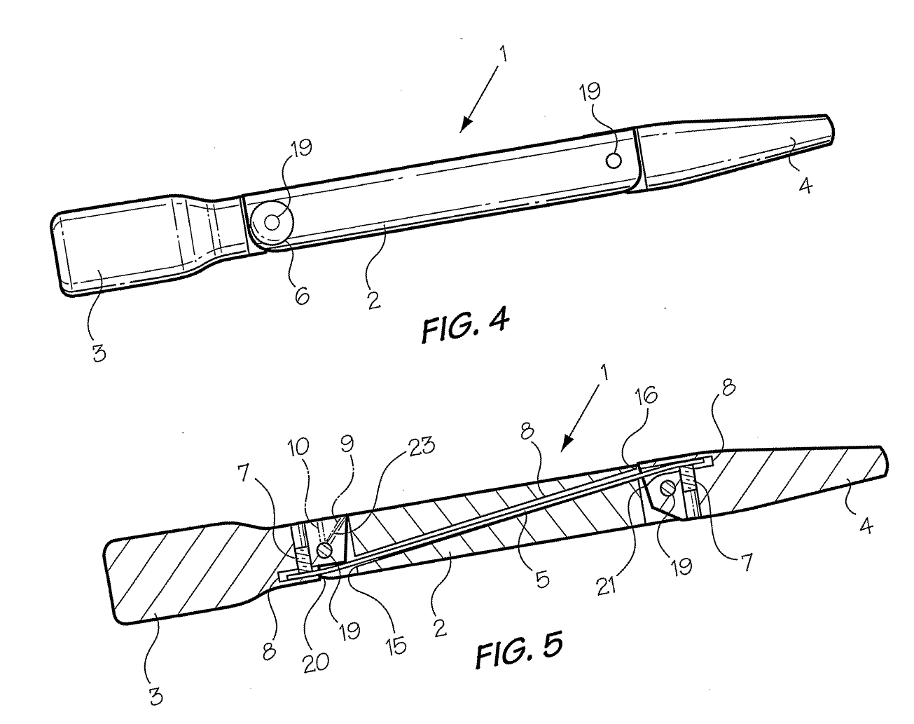

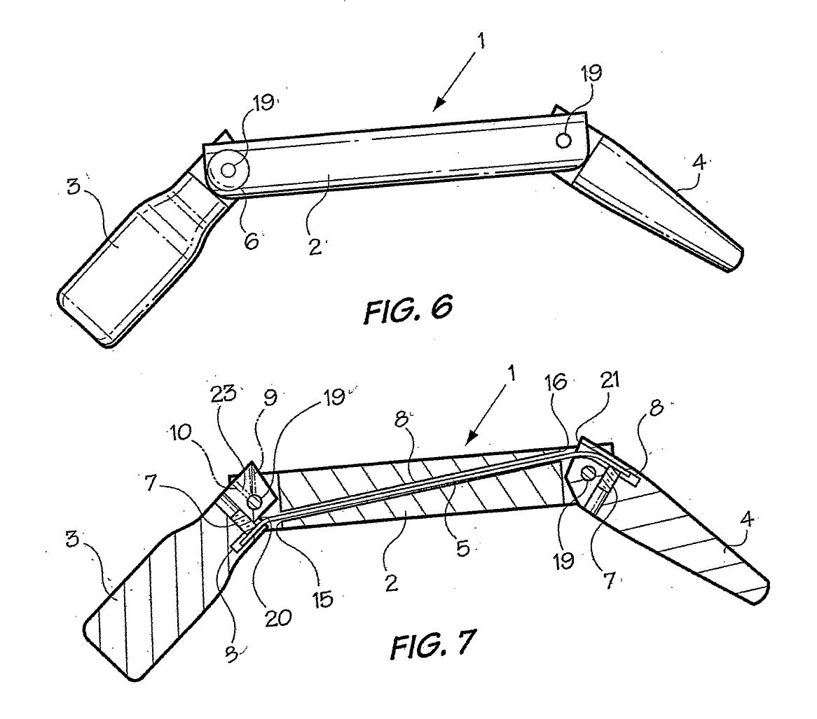

FIGS. 1 to 7 show a hitch pin 1 according to an embodiment of the present invention. The hitch pin 1 comprises a handle 3 connected to a guide member 4 by a pin member 2. The handle 3 is connected pivotally to the first end of the pin member 2 for movement between a first position in which the handle 3 is substantially aligned with the pin member 2 (FIGS. 4 and 5) and a second position in which the handle 3 is disposed at an angle to the pin member 2 (FIGS. 6 and 7). The guide member 4 is connected pivotally to the second end of the pin member 2, also for movement between a first position in which the guide member 4 is substantially aligned with the pin member 2 (FIGS. 4 and 5) and a second position in which the guide member 4 is disposed at an angle to the pin member 2 (FIGS. 6 and 7). When the handle 3 and guide member 4 are coordinately in the first position (FIGS. 4 and 5), the hitch pin 1 of the present invention can easily and quickly be inserted through a hitch orifice resulting from the aligned openings in articles that are to be coupled together. In the first position, the hitch pin 1 can be inserted through the hitch orifice with the guide member 4 being inserted first. Once the hitch pin 1 has been inserted through the hitch orifice, the handle 3 can be physically, or by the force of gravity, moved to the second position thus resulting in the guide member 4 being coordinately moved to the second position. When the handle 3 and guide member 4 are in the second position, portions proximate to the pin member 2 of the handle 3 and guide member 4 form an angle relative to the orifice. This arrangement will limit lateral movement of the hitch pin 1 through the hitch orifice.

A linkage means 5 that extends from the handle 3 through the pin member 2 and terminates in the guide member 4 is provided under tension when the hitch pin 1 is in the first position, thus aligning the guide member 4, pin member 2 and handle 3 along a substantially longitudinal axis. When the handle 3 is moved into the second position, the guide member 4 coordinately moves into the second position and the distance between the handle 3 and the guide member 4 decreases, thus relieving the tension in the linkage means 5. Once the tension in the linkage means 5 has been relieved, the handle 3 and guide member 4 form an angle relative to the pin member 2.

The pin member 2 of the hitch pin 1 is provided as an elongated structure defining a longitudinal axis with U-shaped recesses 17, 18 provided on each end. Typically, the pin member 2 is provided in a solid material, such as steel, aluminum, titanium and alloys thereof. The shape and length of the pin member 2 will be determined by the width and shape of the hitch orifice. In addition, at least one stop member 6 is provided on the pin member 2 proximate to the first end of the pin member 2, which prevents the hitch pin 1 from being inserted too far into the hitch orifice. Typically, two stop members 6 are provided in positions opposite to one another on the surface of the pin member 2 and in the vicinity of the end connected to the handle 3.

The handle 3 is inserted into the U-shaped recess 18 provided on the first end of the pin member 2 and is connected to the pin member 2 by a pin 19, which allows the handle 3 to pivot relative to the pin member 2. The pin 19 transverses the pin member 2 of the hitch pin 1 perpendicular to the direction of the U-shaped recess 18. The handle 3 is provided such that the end which is connected to the pin member 2 fits in the U-shaped recess 18 and is substantially the same shape as the U-shaped recess 18. To maintain the hitch pin 1 in either the first or second position, a catch 23 can be provided on the handle 3 in the vicinity of the end of the handle 3 connected to the pin member 2, which corresponds to first and second notches 9, 10 provided on the medial side of the U-shaped recess 18 on the pin member 2. The catch 23 can engage the first notch 9 to maintain the handle 3 in the first position. When the handle 3 is moved to the second position the catch 23 can engage the second notch 10 to maintain the handle 3 in the second position. The opposite end of the handle 3 can be provided in any shape that can easily be handled by the operator. In a preferred embodiment, the handle 3 is dimensioned to be sufficiently greater in diameter than the diameter of the hitch orifice and of sufficient weight to be held in the second position by the force of gravity.

The guide member 4 is inserted into the U-shaped recess 17 provided on the second end of the pin member 2 and is connected to the pin member 2 by a pin 19, which allows the guide end 4 to pivot relative to the pin member 2. The pin 19 transverses the pin member 2 of the hitch pin 1 perpendicular to the direction of the U-shaped recess 17. The guide member 4 is provided such that the end which is connected to the pin member 2 fits in the U-shaped recess 17 and is substantially the same shape as the U-shaped recess 17. The opposite end of the guide member 4 is typically provided in a substantially conical shape, to allow for easy insertion through the hitch orifice. However, the only limitation on the shape and size of the guide member 4 is that it is substantially smaller than the size of the hitch orifice.

A channel 8 extends through the pin member 2 from an opening 15 in the vicinity of the lowermost part of the first end of the pin member 2 to an opening 16 opposite and in the vicinity of the uppermost part of the second end of the pin member 2. Channel 8 also extends into handle 3 at opening 20 and into guide member 4 at opening 21. The channel 8 is dimensioned to receive the linkage means 5.

The linkage means 5 connects the handle 3 to the guide member 4 by passing through the channel 8 provided in the pin member 2. The linkage means 5 is channeled at one end into the handle 3 and held in position by a screw 7. The opening 20 for the channel 8 provided in the handle 3 (FIG. 2) is substantially opposite from the opening 15 provided in the vicinity of the lowermost part of the first end of the pin member 2. The opening 20 for the channel provided in the handle 3 is spaced from the end of the handle 3 in a plane substantially different from that of the handle 3 end, thus exposing a length of the linkage means 5 between the opening 15 in the pin member 2 and the opening 20 in the handle 3. The opposite end of the linkage means 5 is channeled into the guide member 4 and is also held in position by a screw 7. Typically, the screws 7 are provided such that the screw 7 in handle 3 engages linkage means 5 from the top and screw 7 in guide end 4 engages linkage means 5 from the bottom. The opening 21 for the channel 8 provided in the guide member 4 (FIG. 3) is substantially opposite from the opening 16 provided in the vicinity of the uppermost part of the second end of the pin member 2. The opening 21 is typically provided in substantially the same plane as the end of the guide member 4 and has an oval shape, which allows the linkage means 5 to move freely from a position corresponding to the first position of the hitch pin 1 and position corresponding to the second position of the hitch pin 1.

Typically, the linkage means 5 is made of a flexible cable, such as high-quality aircraft cable or wire rope. Alternatively, the linkage means 5 may be provided as a solid rod. In order for the rod to function as a linkage means 5, two pivot points proximate to the ends of the rod must be provided. The first pivot point must be provided in the vicinity of the opening 20 for the channel 8 provided in the handle 3 and the other pivot point must be provided in the vicinity of the opening 21 for the channel 8 provided in the guide member 4. As an additional embodiment, when the linkage means 5 is provided as rigid linkage then the pin member 2 can be provided as a hollow closed-end cylinder with openings 15, 16 on the first and second ends thereof.

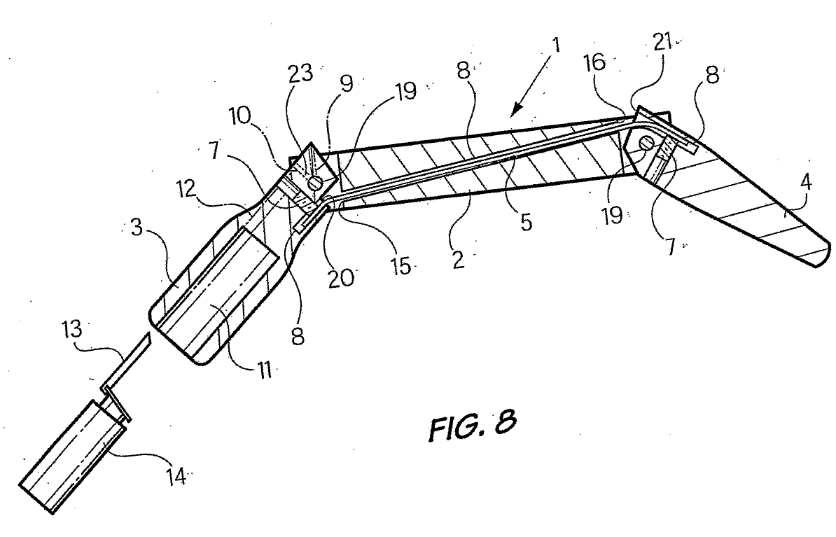

FIG. 8 shows a hitch pin 1 according to a further embodiment of the present invention. To prevent unauthorized removal of the hitch pin 1 when in the second position, a locking mechanism comprising a locking cylinder 14 and locking pin member 13 can be provided in the handle 3. In order for the locking mechanism to be inserted into the handle 3, the handle 3 must be hollowed out in the shape of the locking cylinder 11 and locking pin 12. The locking pin member 13 is coupled to the locking cylinder 14 and extends the length of the handle 3 to engage the pin member 2 when the handle 3 is in the second position and the locking cylinder 14 is in the locked position. When the locking cylinder 14 is in the unlocked position, the locking pin member 13 disengages the pin member 2, which allows the handle 3 to move freely between the first and second position. The locking cylinder 14 typically moves between the unlocked and locked positions by the use of a key.

### INDUSTRIAL APPLICABILITY

The hitch pin of the present invention provides a quick and easy to use alternative for securing the coupling of two objects together. Compared to other hitch pins already known in the art, the present invention avoids the use of small individual components that can be easily misplaced or dropped when out in the field. Moreover, the limited number of moving parts in the present hitch pin decreases the likelihood of mechanical failure and increases the longevity of the hitch pin.

1. A hitch pin comprising:
a pin member having a first end and a second end and dimensioned to fit into a hitch orifice, said pin member defining a longitudinal axis, a handle connected pivotally to the first end of said pin member for movement between a first position in which the handle is substantially aligned with the pin member and a second position in which the handle is disposed at an angle to the pin member,
a guide member dimensioned to fit into the hitch orifice, the guide member connected pivotally to the second end of said pin member for movement between a first position in which the guide member is substantially aligned with the pin member and a second position in which the guide member is disposed at an angle to the pin member, and
a linkage means connected at one end to the handle and at another end to the guide member for transmitting a pivotal movement of the handle to a corresponding pivotal movement of the guide member.

2. The hitch pin according to claim 1, wherein the linkage means is a rigid linkage connected at one end to the handle at a point offset from the longitudinal axis and connected at the other end to the guide member at a point offset from the longitudinal axis so that a pivotal movement of the handle causes a corresponding pivotal movement of the guide member.

3. The hitch pin according to claim 1, wherein the linkage means is a flexible cable and the pin member has a channel extending between the first end and the second end thereof, the channel dimensioned to received the cable for a sliding movement of the cable along the channel, the cable connected to the handle and to the guide member at a point each offset from the longitudinal axis of the pin member.

4. The hitch pin according to claim 3, wherein the flexible cable is aircraft cable or wire rope.

5. The hitch pin according to claim 1, wherein said guide member has a portion proximate to the pin member which forms an angle relative to the orifice when the guide member is in the second position.

6. The hitch pin according to claim 1, wherein said handle has a portion proximate to the pin member which forms an angle relative to the orifice when the handle is in the second position.

7. The hitch pin according to claim 1, wherein said handle is dimensioned to be larger than said hitch pin orifice.

8. The hitch pin according to claim 1, wherein said handle is substantially weighted to be held in the second position by gravity.

9. The hitch pin according to claim 1, further comprising first and second notches disposed on the pin member proximate to the first end of the pin member.

10. The hitch pin according to claim 1, further comprising a catch provided on the handle proximate to the pin member.

11. The hitch pin according to claim 10, wherein said catch engages said first notch to maintain the handle in a first position in which the handle is substantially aligned with the pin member.

12. The hitch pin according to claim 10, wherein said catch engages said second notch to maintain the handle in the second position in which the handle is disposed at an angle to the pin member.

13. The hitch pin according to claim 1, further comprising a locking mechanism provided in the handle, wherein said locking mechanism prevents movement of the handle from the second position to the first position when in a locked position.

14. The hitch pin according to claim 1, further comprising stop members disposed on the pin member proximate to the first end of the pin member.
